(19) United States
(12) Patent Application Publication
(10) Pub. No.: US 2025/0351128 A1
(43) Pub. Date: Nov. 13, 2025

(54) DYNAMIC SUB-BAND OPERATION ASSISTANCE INFORMATION

(71) Applicant: QUALCOMM Incorporated, San Diego, CA (US)

(72) Inventors: Gaurang NAIK, San Diego, CA (US); Youhan KIM, Saratoga, CA (US); Chao ZOU, San Jose, CA (US); Naveen Kumar KAKANI, Flower Mound, TX (US); Madhusudhan Rao DARSIPUDI, Sunnyvale, CA (US); George CHERIAN, San Diego, CA (US); Abhishek Pramod PATIL, San Diego, CA (US); Alfred ASTERJADHI, San Diego, CA (US); Sai Yiu Duncan HO, San Diego, CA (US); Sanket Sanjay KALAMKAR, San Diego, CA (US); Giovanni CHISCI, San Diego, CA (US); Sherief HELWA, San Diego, CA (US)

(21) Appl. No.: 18/658,690

(22) Filed: May 8, 2024

(51) Int. Cl. H04W 72/0453; H04W 72/52

(52) U.S. Cl. CPC H04W 72/0453; H04W 72/52

(57) ABSTRACT

This disclosure provides methods, components, devices and systems for dynamic sub-band operation information. Some aspects more specifically relate to transmission of information from APs to STAs to aid in DSO sub-band selection. For example, such information may indicate a quantity of clients that have selected each DSO sub-band, a quantity of clients that have selected each DSO sub-band and are actively communicating, a rolling average of active STAs on each DSO sub-band, a recommendation of one or more DSO sub-bands, or any combination thereof. In some examples, such information may be provided on a more narrow basis (such as on a per-20 MHz subchannel basis or other individual sub-band basis) or on a broader basis (such as on a per-80 MHz subchannel basis or a group basis, such as on a per-group of sub-band basis).

### TECHNICAL FIELD

This disclosure relates generally to wireless communication and, more specifically, to dynamic sub-band operation information.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by an access point (AP). The method may include transmitting information associated with dynamic sub-band operation (DSO) between the AP and one or more stations (STAs) associated with the AP, where the information indicates one or more of: which of the one or more station (STA) s are associated with each DSO sub-band of a set of multiple DSO sub-bands supported by the AP and a recommendation for one or more DSO sub-bands of the set of multiple DSO sub-bands supported by the AP, receiving, from a first STA, an indication of one or more selected DSO sub-bands of the set of multiple DSO sub-bands, and communicating with the first STA in accordance with at least one of the one or more selected DSO sub-bands.

Another innovative aspect of the subject matter described in this disclosure can be implemented in an apparatus for wireless communications at an access point AP. The apparatus may include a processing system that includes processor circuitry and memory circuitry that stores code. The processing system may be configured to cause the AP to transmit information associated with dynamic sub-band operation (DSO) between the AP and one or more stations (STAs) associated with the AP, where the information indicates one or more of: which of the one or more STAs are associated with each DSO sub-band of a set of multiple DSO sub-bands supported by the AP and a recommendation for one or more DSO sub-bands of the set of multiple DSO sub-bands supported by the AP, receive, from a first STA, an indication of one or more selected DSO sub-bands of the set of multiple DSO sub-bands, and communicate with the first STA in accordance with at least one of the one or more selected DSO sub-bands.

Another innovative aspect of the subject matter described in this disclosure can be implemented in an apparatus for wireless communications at an AP. The apparatus may include means for transmitting information associated with dynamic sub-band operation (DSO) between the AP and one or more stations (STAs) associated with the AP, where the information indicates one or more of: which of the one or more STAs are associated with each DSO sub-band of a set of multiple DSO sub-bands supported by the AP and a recommendation for one or more DSO sub-bands of the set of multiple DSO sub-bands supported by the AP, means for receiving, from a first STA, an indication of one or more selected DSO sub-bands of the set of multiple DSO sub-bands, and means for communicating with the first STA in accordance with at least one of the one or more selected DSO sub-bands.

Another innovative aspect of the subject matter described in this disclosure can be implemented in a non-transitory computer-readable medium storing code for wireless communications is described. The code may include instructions executable by one or more processors to transmit information associated with dynamic sub-band operation (DSO) between the AP and one or more stations (STAs) associated with the AP, where the information indicates one or more of: which of the one or more STAs are associated with each DSO sub-band of a set of multiple DSO sub-bands supported by the AP and a recommendation for one or more DSO sub-bands of the set of multiple DSO sub-bands supported by the AP, receive, from a first STA, an indication of one or more selected DSO sub-bands of the set of multiple DSO sub-bands, and communicate with the first STA in accordance with at least one of the one or more selected DSO sub-bands.

In some examples of the method, apparatuses, and non-transitory computer-readable medium described herein, the information indicates which of the one or more STAs may have transmitted DSO sub-band selection indications.

In some examples of the method, apparatuses, and non-transitory computer-readable medium described herein, transmitting the information may include operations, features, means, or instructions for transmitting the information via a unicast transmission in response to reception of a query from the first STA and transmitting the information via a broadcast transmission; or both.

Some examples of the method, apparatuses, and non-transitory computer-readable medium described herein may further include operations, features, means, or instructions for transmitting the information via the unicast transmission in response to reception of the query from the first STA includes transmitting the information on a per-sub-band basis and transmitting the information via the broadcast transmission includes transmitting the information on a per-sub-band group-basis.

In some examples of the method, apparatuses, and non-transitory computer-readable medium described herein, transmitting the information may include operations, features, means, or instructions for transmitting the information in a dedicated information element or in an operations information element.

In some examples of the method, apparatuses, and non-transitory computer-readable medium described herein, the information indicates one or more quantities of the STAs associated with each DSO sub-band on an individual DSO sub-band basis, on a DSO sub-band group basis, or both.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a channel access protocol that supports dynamic sub-band operation information.

FIG. 3 shows an example of a DSO communications system that supports dynamic sub-band operation information.

FIG. 4 shows an example of a reporting scheme that supports dynamic sub-band operation information.

FIG. 5A-5C show examples of a DSO timeline that supports dynamic sub-band operation information.

FIG. 6 shows an example of a process flow that supports dynamic sub-band operation information.

FIG. 7 shows a block diagram of an example wireless communication device that supports dynamic sub-band operation information.

FIG. 8 shows a flowchart illustrating an example process performable by or at an access point (AP) that supports dynamic sub-band operation information.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, stations (STAs) and access points (APs) may operate in accordance with dynamic sub-band operation (DSO) in which different sub-bands may be used for communications between the AP and a group of STAs. For example, a DSO STA may switch from a primary sub-band to a DSO sub-band during a padding duration. After switching, the DSO should be capable of transmitting on the DSO sub-band within a short inter-frame space (SIFS). However, meeting these transmit considerations within a SIFS may not be feasible for a STA on an arbitrary quantity of DSO sub-bands. Further, such a STA may not be aware of local conditions or traffic that may influence DSO switching.

Various aspects relate generally to DSO and transmission of information from APs to STAs to aid in DSO sub-band selection. For example, such information may indicate a quantity of clients that have selected each DSO sub-band, a quantity of clients that have selected each DSO sub-band and are actively communicating, a rolling average of active STAs on each DSO sub-band, a recommendation of one or more DSO sub-bands, or any combination thereof. In some examples, such information may be provided on a narrower basis (such as on a per-20 MHz subchannel basis or other individual sub-band basis) or on a broader basis (such as on a per-80 MHz subchannel basis or a group basis, such as on a per-group of sub-band basis).

In some examples, the information may be transmitted via a solicited unicast transmission in response to a query from a STA or via a broadcast transmission (such as at regular or semi-regular intervals) in an unsolicited fashion. In some examples, more granular information may be provided in solicited unicast transmissions and more broad information may be provided in unsolicited broadcast transmissions. The AP may provide the information to the STA in an information element (such as a dedicated information element or another information element, such as an operations information element). The information may include values expressed with a reduced quantity of bits alongside a multiplier value that is to be applied to the values indicated in the information. The STA may request a granularity of the reporting information (such as whether the information is to include quantities of STAs that have selected DSO sub-bands on a 20 MHz basis or an 80 MHz basis (or other bandwidth bases)) and the AP may transmit the information in accordance with the request. In some examples, the AP may discourage or disallow selection of one or more otherwise available DSO sub-bands due to traffic conditions associated with such DSO sub-bands.

Particular aspects of the subject matter described in this disclosure can be implemented to realize one or more of the following potential advantages. In some examples, by providing the information to the STA, the described techniques can be used to aid the STA in selecting better-performing DSO sub-bands, thereby improving communications quality, throughout, resource utilization, flexibility, and reliability may be increased while reducing overhead and latency, as the STAs are better able to select DSO sub-bands that are more suitable for operation of the STAs and the AP. By providing DSO information on a narrower basis (such as on a per-20 MHz subchannel basis or other individual sub-band basis), more granular information may be provided to the STA, resulting in a more informed selection of DSO sub-bands. By providing DSO information on a broader basis (such as on a per-80 Mhz subchannel basis or a group basis), signaling overhead may be reduced. By providing more granular information in solicited unicast transmissions and more broad information in unsolicited broadcast transmissions, more detailed information may be provided to some STAs as requested while still reducing overall signaling overhead. By including values expressed with a reduced quantity of bits alongside a multiplier value that is to be applied to the values indicated in the information, signaling overhead associated with transmitting the information may be reduced while still allowing for detailed information reporting via values capable of substantial variation. By allowing the STA to request a granularity of the reporting information and the AP to transmit the information in accordance with the request, overall signaling overhead may be reduced while maintaining the ability to provide detailed information, which increases communications quality due to improved DSO sub-band selection. By discouraging or disallowing selection of one or more otherwise available DSO sub-bands due to traffic conditions associated with such DSO sub-bands, STAs may obtain additional information about DSO sub-bands that was not previously available to such STAs, resulting in reduced traffic congestion on DSO sub-bands, and increased communications throughput between the AP and the STAs.

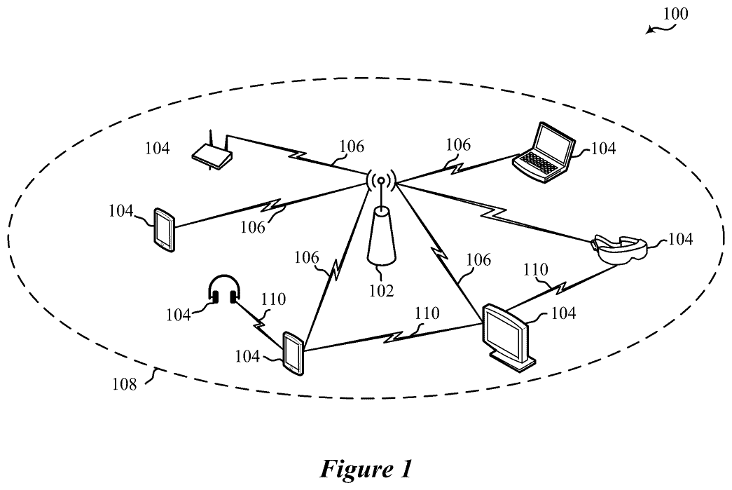

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while an UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

In some examples, the AP 102 and the STA 104 may communicate in accordance with DSO switching operations. For example, the AP 102 may transmit information to the STA 104 to aid the STA 104 in selecting one or more DSO sub-bands to be used for DSO communications. Such information may include indications of how many clients have previously selected DSO sub-bands (such as on a per-sub-band basis or on a basis of groups of sub-bands) or may include one or more recommended DSO sub-bands for the STA 104 to use. The STA 104 may indicate to the AP 102 one or more selected DSO sub-bands in which the AP 102 may schedule subsequent communications between the AP 102 and the STA 104.

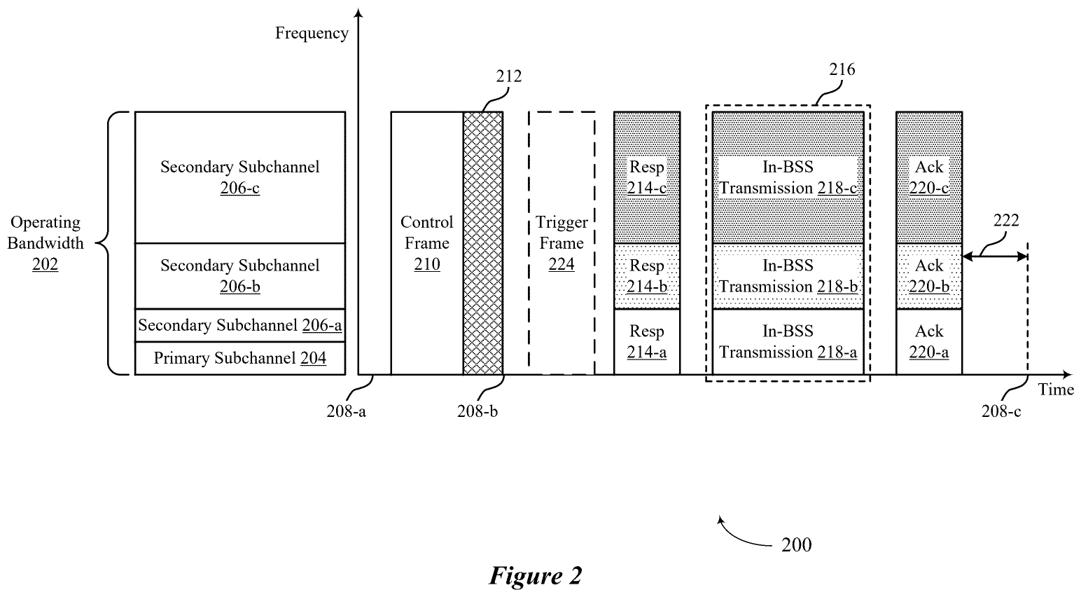

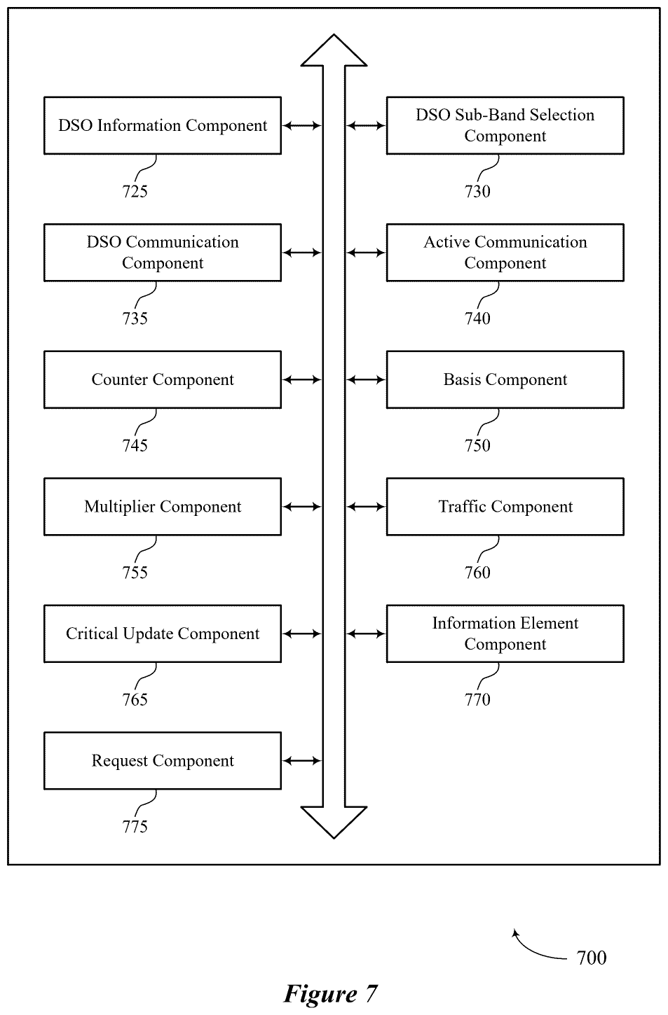

FIG. 2 shows an example of a channel access protocol 200 that supports dynamic sub-band operation information. A. wireless communication network or wireless communications system, as described herein, may support the channel access protocol 200. For example, an AP 102 may communicate with multiple STAs 104 in accordance with the channel access protocol 200. For example, if the AP 102, one or more STAs 104, or both are operating in a DSO mode (as described with reference to FIG. 7), the AP 102 and the one or more STAs 104 may communicate according to the channel access protocol 200 to support dynamically switching subchannels to efficiently utilize the operating bandwidth 202 of the AP 102. It should be noted that, while discussions herein describe channels having example bandwidths, the techniques described throughout may be applied to any DSO sub-band (sometimes referred to as sub-channels) that is of any bandwidth. This includes sub-bands that included additional sub-bands within them (e.g., a 40 Mhz sub-band or an 80 Mhz sub-band that includes one or more 20 Mhz sub-bands).

In some aspects, the operating bandwidth 202 of the AP 102 may include one or more subchannels, such as a primary subchannel 204 (such as primary 20 (P20) spanning 20 MHz) and one or more secondary subchannels. In some implementations, the secondary subchannels may include a first secondary subchannel 206-a (such as secondary 20 (S20) spanning 20 MHz), a second secondary subchannel 206-b (such as secondary 40 (S40) spanning 40 MHz), and a third secondary subchannel 206-c (such as secondary 80 (S80) spanning 80 MHz). One or more STAs 104 may indicate support for switching to one or more secondary subchannels for DSO, which may include the S40, the S80, any sub-channel included within the S40 or the S80 (e.g., a 20 Mhz channel) or any other DSO sub-channel, regardless of the frequency bandwidth of such channels or whether they are included within another channel. For example, a first STA 104 may not indicate support for DSO, a second STA 104 may indicate support for the second secondary subchannel 206-b, and a third STA 104 may indicate support for the second secondary subchannel 206-b and the third secondary subchannel 206-c.

At time 208-a, the STAs 104 may communicate via the primary subchannel 204. For example, the STAs 104 may initially park on the primary subchannel 204. Based on an operating bandwidth for the STAs 104, one or more of the STAs 104 may further communicate via one or more secondary subchannels. For example, if the first STA 104 operates with a narrowband operating bandwidth of 40 MHz, the first STA 104 may communicate via the primary subchannel 204 and the first secondary subchannel 206-a, collectively spanning 40 MHz.

The AP 102 may transmit a control frame 210 (such as a DSO ICF or a DSO Announcement frame or a combination thereof) to the STAs 104 assigning secondary subchannels (such as one or more frequency resources within the secondary subchannels) to one or more of the STAs 104 for DSO. The control frame 210 may be based on the indicated secondary subchannels supported by the STAs 104. For example, the control frame 210 may assign the second secondary subchannel 206-b (such as S40) to the second STA 104 and may assign the third secondary subchannel 206-c (such as S80) to the third STA 104 based on the second STA indicating support for the secondary subchannel 206-b (such as S40) and the third STA indicating support for the secondary subchannel 206-c (such as S80). In some implementations, the control frame 210 may assign one or more frequency resources to a STA 104 that includes a frequency portion or chunk that is relatively smaller than a full subchannel span. In some such implementations, the STA 104 may determine to switch to a subchannel including the assigned one or more frequency resources. Additionally, or alternatively, the control frame 210 may assign frequency resources spanning multiple subchannels of the indicated subchannels, and the STA 104 may determine to switch to operating via the multiple subchannels based on the control frame 210. The control frame 210 may be an example of a non-high-throughput (HT) DUP frame (such as a trigger frame duplicated across multiple subchannels of the operating bandwidth 202), an MU-RTS frame, a Buffer Status Report Poll (BSRP) Trigger frame, a DSO Announcement frame or a DSO ICF. The control frame 210 may trigger the one or more STAs 104 to switch to the assigned secondary subchannels for DSO communications.

The AP 102 may communicate random (or semi-random) signaling as padding 212 signaling or may refrain from communicating during some padding 212 time that provides enough time for the STAs 104 to process the control frame 210 and switch to the assigned secondary subchannels. For example, the AP 102 may transmit the padding 212 signaling to occupy the channel while the STAs 104 switch operating frequencies. In some implementations, the length of the padding 212 may be based on STA capabilities. For example, if the second STA 104 can process the control frame 210 and tune to the assigned frequency (such as the second secondary subchannel 206-b) in 16 microseconds (μs) and the third STA 104 can process the control frame 210 and tune to the assigned frequency (such as the third secondary subchannel 206-c) in 32 μs, the AP 102 may set the length of the padding 212 (such as the padding 212 signaling) to span at least 32 μs. The STAs 104 may report delay times for processing the control frame 210, switching to the assigned subchannel, or both to the AP 102 in capability signaling, operational mode signaling, or both, where the delay times may be STA-specific (such as client-specific), link-specific, or both. At time 208-b, the STAs 104 may complete switching to the assigned subchannels. For example, the first STA 104 may remain on the primary subchannel 204 and the first secondary subchannel 206-a, the second STA 104 may switch to the second secondary subchannel 206-b, and the third STA 104 may switch to the third secondary subchannel 206-c. In some implementations, the AP 102 may transmit a trigger frame 224 to confirm that the STAs 104 completed switching to the designated (such as assigned) subchannels. The trigger frame 224 may be an example of a DSO confirmation frame, a BSRP trigger frame, a control frame, or any other trigger frame.

Once the STAs 104 have switched to the assigned subchannels, the STAs 104 may perform a CCA-energy detection (ED) during a short inter-frame space (SIFS) on the assigned subchannels (such as the designated subchannels) to determine whether the assigned subchannels are available for communication. For example, the AP 102 may assign the second secondary subchannel 206-b to the second STA 104 based on the AP 102 failing to detect other communications occurring via the second secondary subchannel 206-b. However, the second STA 104 may switch to the second secondary subchannel 206-b and may perform the CCA-ED to detect if another device hidden from the AP 102 but detectable by the second STA 104 is transmitting via the second secondary subchannel 206-b. The STAs 104 may transmit response frames to the AP 102 via the assigned subchannels based on determining that the assigned subchannels are available for communications (such as based on the CCA-ED results). For example, the first STA 104 may transmit a response frame 214-a (such as a clear to send (CTS) signal or a QoS null frame with buffer status report) via the primary subchannel 204 and the first secondary subchannel 206-a, the second STA 104 may transmit a response frame 214-b via the second secondary subchannel 206-b, and the third STA 104 may transmit a response frame 214-c via the third secondary subchannel 206-c. The response frames may indicate to the AP 102 that the STAs 104 are ready to communicate frames via the assigned subchannels in the DSO mode.

Based on receiving the response frames, the AP 102 may exchange frames with the STAs 104 via the assigned subchannels (such as in a single PPDU 216, such as an EHT MU PPDU). For example, the AP 102 may transmit a PPDU 216 include multiple MPDUs corresponding to the different assigned subchannels. The first STA 104 may receive an in-BSS transmission 218-a via the primary subchannel 204 and the first secondary subchannel 206-a (such as spanning 40 MHz), the second STA 104 may receive an in-BSS transmission 218-b via the second secondary subchannel 206-b (such as spanning 40 MHz), and the third STA 104 may receive an in-BSS transmission 218-c via the third secondary subchannel 206-c (such as spanning 80 MHz). Additionally, or alternatively, the STAs 104 may transmit PPDUs 216, MPDUs, or a combination thereof to the AP 102 via the assigned subchannels. The AP 102 and the STAs 104 may exchange more than one SIFS-separated PPDUs 216 while operating via the assigned subchannels in the DSO mode.

Based on exchanging one or more frames via the assigned subchannels, the AP 102, the STAs 104, or both may transmit acknowledgment frames to indicate successful reception of the one or more frames. For example, the first STA 104 may transmit an acknowledgment frame 220-a via the primary subchannel 204 and the first secondary subchannel 206-a, the second STA 104 may transmit an acknowledgment frame 220-b via the second secondary subchannel 206-b, and the third STA 104 may transmit an acknowledgment frame 220-c via the third secondary subchannel 206-c. The STAs 104 (such as the second STA 104 and the third STA 104) may continue monitoring the assigned subchannels after communicating the acknowledgment frames to listen for any additional frames. The STAs 104 may remain on the assigned subchannels for an additional timeout interval 222, such as a SIFS time, a slot time, a receive physical start delay time (such as spanning 20 μs), or a combination thereof. If a STA 104 fails to receive a packet addressed to the STA 104 via the assigned subchannel by the end of the additional timeout interval 222, the STA 104 may switch back to the primary subchannel 204. For example, at time 208-c, the second STA 104 may initiate switching back from operating via the second secondary subchannel 206-b to operating via at least the primary subchannel 204, and the third STA 104 may initiate switching back from operating via the third secondary subchannel 206-c to operating via at least the primary subchannel 204. Additionally, or alternatively, the control frame 210 may indicate a time duration (such as the additional timeout interval 222) for a STA 104 to remain operating via the assigned subchannel before switching back to the primary subchannel 204.

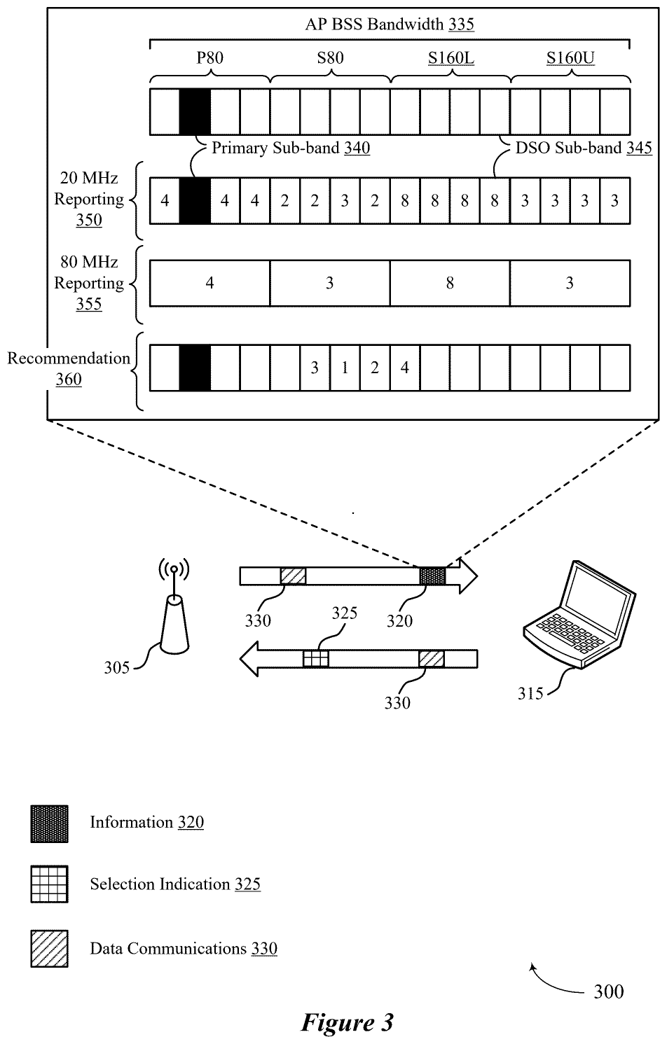

FIG. 3 shows an example of a DSO communications system 300 that supports dynamic sub-band operation information.

The DSO communications system 300 may include the AP 305, which may be an example of one or more APs discussed in relation to other figures. The wireless communications system 300 may include the STA 315, which may be an example of STAs discussed in relation to other figures. In some examples, the AP 305 and the STA 315 may communicate via one or more communication links. Though some examples describe some example bandwidths, such examples are not limiting and any bandwidth also may be used in such examples. For example, though an example may discuss a 20 MHz bandwidth of a DSO sub-band 345, it is to be understood that such a DSO sub-band 345 may be of any bandwidth. In some examples, a discussion of an example bandwidth may indicate a minimum bandwidth that may be used. For example, in some implementations involving a 20 MHz bandwidth, the bandwidth may be 20 MHz or greater.

Dynamic sub-band operation (DSO) may permit ultra high reliability (UHR) APs to utilize BSS bandwidth effectively. This can be accomplished by an AP instigating, on a per-transmission opportunity (TXOP) basis, a transition of one or more STAs from communicating on a primary sub-band to a secondary sub-band, also referred to as a DSO sub-band 345. In such examples, the AP BSS bandwidth 335 may include or correspond to multiple DSO sub-bands 345 and the primary sub-band 340 also may be included in or correspond to the AP BSS bandwidth 345. Such a STA may transition from operation associated with the primary sub-band 340 to one or more of the DSO sub-bands 340.

For example, in DSO, a DSO STA, such as the STA 315, may transition from the primary sub-band 340 to a DSO sub-band 345 during the padding duration provided in the DSO ICF (such as at 812). Following the switch, within the SIFS, the DSO STA should be capable of transmitting on the DSO sub-band 345. Fulfilling these considerations within the SIFS may not be feasible for the STA 315 on an arbitrary quantity of DSO sub-bands 345. For instance, given an AP that supports 320 MHz bandwidth and a DSO STA that operates at 40 MHz, there exist 7 candidate DSO sub-bands 345. Such quantities of sub-bands may be problematic. Therefore, a mechanism, by which the AP and a DSO capable STA negotiate one or more selected DSO sub-bands 345 for communications between that STA and the AP may be implemented. Once the DSO sub-bands 345 are selected, the AP may schedule resources to that STA dynamically (such as within any of the selected DSO sub-bands 345) and the AP 305 and the STA 315 may communicate the data communications 330 within the scheduled resources (such as which may include the selected DSO sub-bands 345).

For example, consider a STA capable of operating in an 80 MHz sub-band, such as the STA 315, operating in a 320 MHz BSS. A primary sub-band (such as P-SB1) and three candidate DSO sub-bands 345 (such as SB2, SB3, and SB4) may be included within the total bandwidth of the AP. In such a scenario, transitioning to all three candidate DSO sub-bands 345 may be problematic for a STA, in that the STA may not be able to switch to the DSO sub-bands 345 within the SIFS. Instead, the STA may select a DSO sub-band 345 (such as SB3) as the chosen DSO sub-band 345 to be used for communications. The AP may subsequently schedule resources to that DSO non-AP STA either in the primary sub-band, P-SB1, or the selected DSO sub-band 345, which is SB3, but not in SB2 or SB4, as those sub-bands were not selected or indicated by the STA.

To support such selection and use of DSO sub-bands 345, a signaling process or procedure may be established or defined. For example, in a first step the AP 305 may provide information 320 to aid the selection of the DSO sub-bands 345 by the STA 315. In some examples, this information 320 may be sent unsolicited (such as in broadcast management frames such as a beacon or a probe response) or it may be solicited by the non-AP STA 315 (such as in a request.). In some examples, in response to the request, the AP 305 may transmit a recommendation 360 (such as part of the information 320) of one or more DSO sub-bands 345 that the AP 305 determines as candidate DSO sub-bands 345. In some examples, such a recommendation may include a prioritization of the recommended DSO sub-band 345. For example, as shown in the recommendation 360, some of the sub-bands are numbered 1, 2, 3, and 4, indicating a priority of recommendation. In some examples, the recommendation 360 may be based on traffic conditions associated with the respective recommended DSO sub-bands 345. In a second step, the non-AP STA 315 may transmit a selection indication 325 to the AP 305 that indicates one or more selected DSO sub-bands 345. This could occur, for example, in situations in which the non-AP STA 315 enables or reenables a DSO mode (such as via a bitmap). In some examples, the AP 305 may refrain from modifying the selection of the DSO sub-bands 345. In some examples, the AP may schedule resources for use by the DSO non-AP STA in the selected DSO sub-bands 345. In some examples, within the indicated bitmap, the operating bandwidth of the DSO non-AP STA 315 may not vary across sub-bands. For instance, if the non-AP STA 315 is capable of, or operating in, 80 MHz on the primary sub-band, it may select other 80 MHz DSO sub-bands 345.

By providing such additional information, clients may make a better-informed selection of DSO sub-bands for communications (e.g., by avoiding selection of DSO sub-bands that are oversubscribed). Without this information, a client that selects from a limited quantity of DSO sub-bands has no basis to select one DSO sub-band over another. As a result, multiple clients may end up selecting the same DSO sub-band, resulting in oversubscription, Further, this may also cause DSO sub-bands to become crowded while leaving others idle or lightly loaded (e.g., undersubscribed). By providing the information to the STAs, the AP provides enables clients to spread out across the DSO sub-bands and improves the probabilities of clients to be served and communicate with improved communications quality, throughout, resource utilization, flexibility, and reliability while while reducing overhead and latency.

In some examples, the information 320 may include different types of information associated with DSO. For example, in some examples, the information 320 may include a quantity of clients that have selected a DSO sub-band 345. For example, as shown in the 20 MHz reporting 350, each DSO sub-band 345 is associated with a quantity, which might be a measure of a quality associated with the DSO sub-band a utilization of the DSO sub-band (such as a quantity of clients that have selected that respective DSO sub-band 345). However, in some implementations, such an approach may not accurately reflect the actual load on the DSO sub-bands 345, since some clients may be inactive, though it may reduce the complexity of the reporting. Additionally, or alternatively, the information 320 may include or indicate a quantity of clients that have selected a DSO sub-band 345 and are actively communicating with the AP 305. This provides a more accurate reflection of how crowded a DSO sub-band 345 is. However, this may involve additional operations for the AP 305 to track and disseminate information on DSO sub-band 345 usage. In some examples, this approach can trigger frequent updates. Additionally, or alternatively, the information 320 may include or indicate a running average (such as over a window of time) of the active STAs on each DSO sub-band 345.

In some examples, the reporting may be included on a per-20 MHz subchannel-basis, such as shown in the 20 MHz reporting 350. Such reporting provides more granular information 320 for 20 or 40 MHz STAs, but may result in signaling overhead or increases in beacon size due to the higher granularity (such as involving more bits). Additionally, or alternatively, reporting may be included on a per-80 MHz subchannel basis, such as shown in the 80 MHz reporting 355. Such reporting results in less signaling overhead but also less granularity of the provided information 320. Such reduced granularity may be acceptable if some STAs (such as a threshold amount of STAs that are associated or communicating with an AP) are 80 MHz capable. Additionally, or alternatively, the AP 305 could select the granularity of reporting based on a BSS configuration (such as based on the least capable DSO STA).

In some examples, the information 320 to be announced may be included in data, control, or management frames. In some examples, the information 320 may be transmitted via a unicast transmission in response to a query received from the STA 315, such as a probe, an association request, a reassociation request, an action frame, a DSO action frame, an A-control, or any combination thereof. Additionally, or alternatively, the AP 305 may transmit the information 320 via a broadcast transmission, such as a beacon, an unsolicited probe response, an unsolicited broadcast probe response, a DSO action frame, a broadcast DSO action frame, or any combination thereof. Additionally, or alternatively, the AP 305 may transmit the information 320 using both broadcast and unicast. For example, solicited information 320 (such as in response to a request from the STA 315) may include the 20 MHz reporting 350 and an unsolicited (such as broadcast) transmission may include the 80 MHz reporting 355. In some examples, any of the reporting may be based on a capability of a single STA (such as a least capable STA).

In some examples, after the AP 305 boots up, the quantity of DSO STAs reported in every 20 MHz subchannel may be 0. However, in response to a STA 315 selecting a DSO sub-band 345, the AP 305 may increment the quantity corresponding to each selected 20 MHz subchannel within the DSO sub-band 345 by 1. For instance, if a STA 315 indicates a bitmap of [1111 0000 1111 0000], the AP 305 may increment by one the quantity corresponding to each of the eight 20 MHz subchannels with bits set to 1. Additionally, or alternatively, if reporting is performed on an 80 MHz-basis, the AP 305 may either report the maximum of the quantity of STAs that have selected the constituent 20 MHz subchannels (such as shown in the 80 MHz reporting 355), or report an average quantity of STAs that have selected the constituent 20 MHz subchannels, rounded to the nearest integer. For example, the 20 MHz subchannels may be divided into groups and the reporting may indicate a greatest quantity indicated within the group or an average quantity across the entire group. In some examples, in response to a STA 315 that has previously selected a DSO sub-band 345 leaving the AP 305's BSS or disabling the DSO mode, the AP 305 may decrement the quantity corresponding to the DSO sub-bands 345.

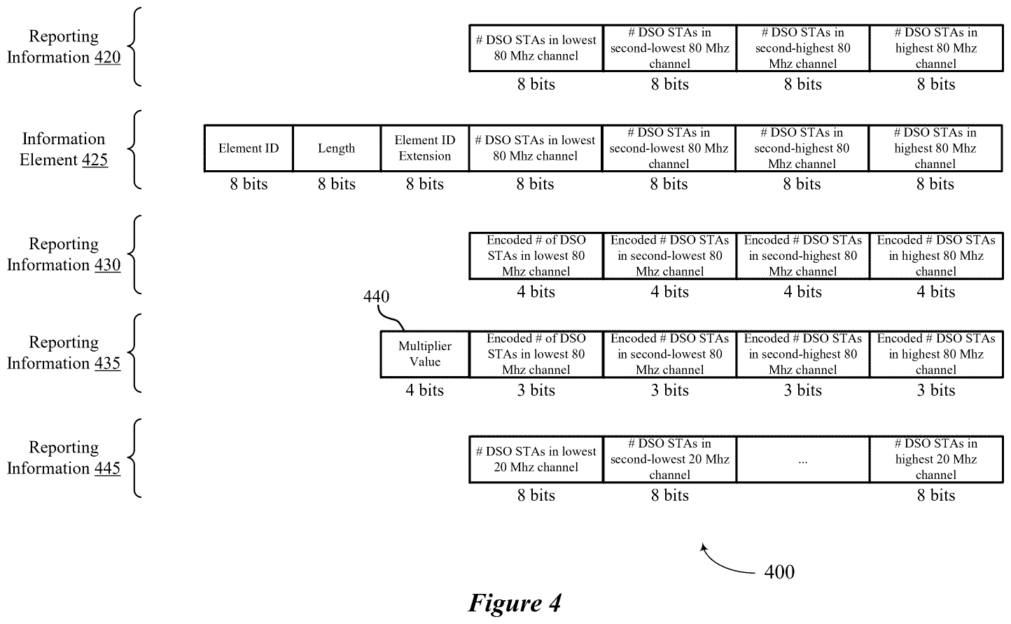

FIG. 4 shows an example of a reporting scheme 400 that supports dynamic sub-band operation information.

The reporting scheme 400 includes various examples of reporting information and information. I. n some examples, the AP may advertise the information in broadcast frames and may attempt to reduce overhead of such transmissions. For example, and as shown in the reporting information 420, the AP may transmit less granular information (such as information on an 80 MHz sub-band basis). For example, such information may include quantities of DSO STAs that have selected the corresponding sub-bands. As described herein, such information may be a greatest quantity of 20 MHz sub-bands within an 80 MHz sub-band or may be an average quantity of some or all 20 MHz sub-bands within the 80 MHz sub-band. In some examples, the information included in the reporting information 420 may be included in an information element, such as the information element 425. The information element 425 may be an operations information elements (such as a UHR Operations element) or an information element dedicated to signaling the information for DSO. The information element 425 shows an example of a dedicated information element.

In some examples, other variants may be possible. For instance, instead of 8 bits per 80 MHz sub-band, the AP may transmit information that is expressed with 3 or 4 bits per 80 MHz (such as shown in the reporting information 430). However, by using only 4 bits, values between 0 and 15 per sub-band may be signaled, which may be less than an actual quantity of clients that have selected the DSO sub-bands. Thus, the AP also may indicate an associated multiplier that is to be applied to the 4-bit quantities to obtain the actual values. For example, the specification may define a multiplier of 2 (such as to signal up to 30 clients per 80 MHz sub-band), 4 (up to 60 clients per 80 MHz sub-band) or 8 (up to 120 clients per 80 MHz sub-band). Thus, if the value carried in the 4 bits is 5 and the multiplier is 2, the quantity of clients that have selected that 80 MHz sub-band is 5×2=10. If an actual quantity cannot be expressed with a multiplier, the AP may err on the side of indicating more clients than are actually associated with a sub-band to reduce or prevent overcrowding.

Additionally, or alternatively, the AP may signal the multiplier within an information element itself. For example, the reporting information 435 may be included in an information element. In this example, the multiplier 440 may be a value between 0 and 15 (such as due to the quantity of 4 bits). Thus, if the multiplier 440 value is 10 and the encoded value for an 80 MHz sub-band is 5, the quantity of clients that have selected that 80 MHz sub-band is 10×5=50. In some examples, such reporting information (or any reporting information described herein) may be carried within one or more broadcast management frames or within an A-Control field of frames transmitted by the AP.

In some examples, the AP may indicate information via unicast transmissions. The reporting information 445 is one example of such information. For example, in situations in which DSO info is carried in a unicast frame, overhead may be a smaller concern because unicast frames are sent at larger PHY rates and are likely to be sent less frequently (such as only upon a corresponding request by the STA). Thus, the reporting information 445 or other information may be expressed in per-20 MHz sub-band reporting. Assuming there are 16 sub-bands within an AP's bandwidth, such a scheme may result in 16 octets of signaling overhead. However, of these octets, one octet corresponding to the primary 20 MHz channel may be skipped, resulting in 15 octets. Additionally, or alternatively, instead of 8 bits, 4 bits may be used per 20 MHz subchannel, resulting in 8 octets total from 4 bits for each sub-band. In some examples, the AP may provide a multiplier value (such as a pre-defined multiplier value or a calculated multiplier value). In some examples, the 4 unused bits corresponding to the primary 20 MHz channel may be used to signal the multiplier.

In some examples, the STA may request the granularity of signaled info. For example, the request frame transmitted by the STA may indicate whether per-20 MHz or per-80 MHz information (or information on another bandwidth basis) is requested.

In some examples, the AP may disallow or discourage the STAs from selecting a DSO sub-band. This could be due to considerations at the AP or traffic conditions (such as OBSS traffic conditions or other traffic conditions). In some examples, the AP may set the value corresponding to such DSO sub-bands to a special value (such as the maximum value) to indicate that a sub-band is disallowed (such as 255 for 8-bit signaling, 15 for 4-bit signaling or 7 for 3-bit signaling). Additionally, or alternatively, the AP may set the value corresponding to such DSO sub-bands to another special value (such as the next-highest value) to indicate that a sub-band is discouraged (such as 254 for 8-bit signaling, 14 for 4-bit signaling or 6 for 3-bit signaling).

In some examples, the AP may indicate whether one or more sub-bands are oversubscribed by using a reserved value. For instance, there might be few STAs that have selected a particular DSO sub-band but, given the traffic profile, those clients are active more frequently. For example, clients that have some types of traffic might be prioritized by the AP and may be scheduled more often, leaving less capacity for further scheduling on that DSO sub-band. In some examples, a client that selects such a DSO sub-band may still be allowed to do so (such as to accommodate other considerations for the STA).

In some examples, updates to the DSO utilization (such as the information indicated to the STA by the AP) may be classified as critical updates and the information may be transmitted as such. For example, in situations in which when a DSO STA first selects a DSO sub-band or updates its selection, the AP may increment a counter (such as a BSS Parameter Change Count subfield corresponding to that link) by 1, and may set the critical update flag field in a beacon or probe response frame that it transmits. In some cases, the critical update flag, the BSS Parameter Change Count subfield, other fields or indications, or any combination thereof may be associated with DSO or a set of communication features (e.g., UHR features) that some devices may not support, such as STAs that do not support DSO. Such devices may ignore such fields or indications or updates to these fields or indications.

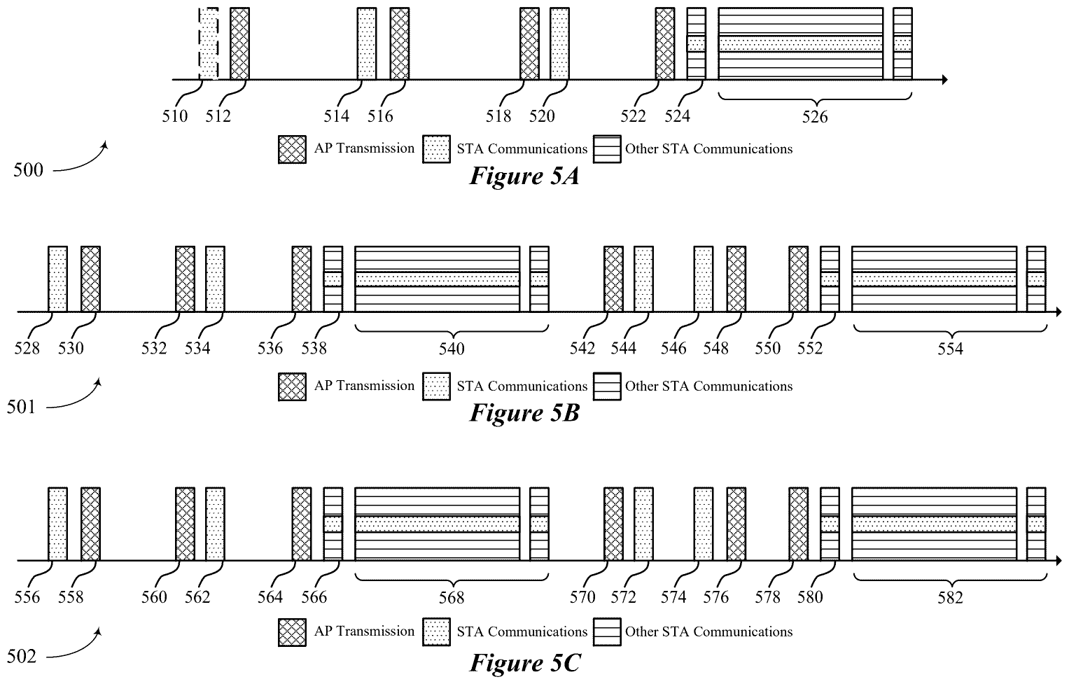

FIG. 5A shows an example of a DSO timeline 500 that supports dynamic sub-band operation information.

The DSO timeline 500 illustrates various DSO events in accordance with the techniques described herein. The DSO timeline 500 describes both situations in which the information that the AP transmits to the STA for DSO is included in broadcast frames (such as a beacon or probe response) as well as situations in which the STA requests the information from the AP.

At 510, the STA may query the AP and request the DSO information. In some examples, the query may be a request frame. At 512, the AP may provide the DSO information to the STA in a response frame. Additionally, or alternatively, in situations in which the STA does not request the DSO information, the AP may transmit a broadcast frame (such as a beacon frame) with the DSO information.

At 514, the STA may transmit a frame to enable the DSO mode. In some examples, the STA may include a bitmap (such as 1111 0000 1111 0000) to indicate the selected DSO sub-bands. At 516, the AP may transmit a control acknowledgment in response.

At 518, the AP may transmit a frame to confirm DSO enablement. In some examples, the AP may include a bitmap (such as 1111 0000 1111 0000) of the selected

DSO sub-bands. At 520, the STA may transmit a control acknowledgement in response.

At 522, the AP may allocate resources for the STA within or associated with the selected DSO sub-bands. At 524, the STA may respond within an allocated DSO sub-band. At 526, the AP and the STA may communicate within an allocated DSO sub-band. Further, the AP may communicate with other STAs (such as those that have also transmitted selection indications) in other sub-bands.

In some examples, instead of providing information to aid the STA in selecting the DSO sub-bands, the AP and STA may exchange one or more frames to negotiate the selected the DSO sub-bands. In such cases, the AP, the STA, or both may not advertise information such as the quantity of STAs that have selected the DSO sub-bands or a quantity of DSO sub-bands that can be supported. Instead the AP, the STA, or both may agree on DSO sub-bands that can be supported via the exchange of the one or more frames.

In some examples, the AP, the STA or both, may have considerations related to adding a new sub-band to its previous selection that may affect the negotiation between the AP and the STA. For example, a selected DSO sub-band may already be selected by more than a threshold quantity of other STAs, which may lead to an oversubscription of those DSO sub-bands. In such cases, the AP may not favor adding another DSO STA to such DSO sub-bands. Additionally, or alternatively, the AP may support the addition of other DSO sub-bands, as such DSO sub-bands may be selected by less than a threshold quantity of the STAs. The threshold quantity of STAs may be internal to the AP implementation and may not be announced by the AP.

In some examples, the AP, the STA, or both may not have such considerations associated with the removal of a DSO sub-band from its previous selection.

In some examples, an enablement of the DSO mode may involve an initial negotiation for the selection of the DSO sub-bands. During this initial negotiation, the STA may indicate an initial selection of DSO sub-bands. If the selected DSO sub-bands are acceptable to the AP, the AP may accept the selected the DSO sub-bands. If one or more of the selected DSO sub-bands are not acceptable to the AP, the AP may reject the selection of all the DSO sub-bands, in which case the DSO mode enablement may be rejected. Alternately, the AP may reject the selection of one or more of the selected DSO sub-bands and accept the selection of one or more of the selected DSO sub-bands, in which case the DSO mode enablement is successful and the AP may schedule resources to the STA only in the selected DSO sub-bands that are accepted.

In some examples, when the AP rejects a selection of one or more or all of the DSO sub-bands, the AP may include a reason or basis for rejecting the selection. For example, the AP may include a field indicating a value of a reason or basis code which may indicate why the AP rejected the selection of one or more of the DSO sub-bands.

In some examples, the AP, the STA, or both may perform a modification of the selected DSO sub-bands. Such modification may involve an addition of one or more DSO sub-bands and/or removal of one or more DSO sub-bands. In some cases, the initiating device (such as the AP) may transmit a frame to request one or more additions of DSO sub-bands or removal of one or more additions of the DSO sub-bands. The responding device (such as the STA) may transmit another frame to either accept or reject the modification of the DSO sub-bands. In some cases, the responding device may be required to accept the deletion of one or more previously selected DSO sub-bands. In some examples, in response to the responding device rejecting a selection of one or more or all of the requested additions to the DSO sub-bands, the responding device may include a reason for rejecting the selection. For example, the STA may include a field indicating a value of a reason code which may indicate why the STA rejected the selection of one or more of the DSO sub-bands requested by the AP.

In some examples, in response to a request to modify the selected DSO sub-bands being rejected, the AP and STA may continue to remain in the DSO mode with the previously selected DSO sub-bands. For example, if the AP and STA had previously agreed to DSO sub-bands 1, 2, and 3 and the AP requested to modify the selection to DSO sub-bands 1, 2, and 4, and if the STA rejected the request, the AP and STA may continue to operate in the DSO mode on sub-bands 1, 2, and 3.

In other examples, in response to a request to modify the selected DSO sub-bands being rejected, the AP and STA may continue to operate in the DSO mode only on the sub-bands that are accepted in the latest exchange. For example, if the AP and STA had previously agreed to DSO sub-bands 1, 2, and 3 and the AP requested to modify the selection to DSO sub-bands 1, 2, and 4, and if the STA rejected the request, the AP and STA may continue to operate in the DSO mode on sub-bands 1 and 2.

In some examples, the one or more frames exchanged by the AP and the STA to negotiate the selected DSO sub-bands may be associated with a link reconfiguration operation. The link reconfiguration operation may involve the exchange of one or more of a link reconfiguration request frame, a link reconfiguration response frame or a link reconfiguration notification frame.

In some examples, the one or more frames exchanged by the AP and the STA to negotiate the selected DSO sub-bands may also be used to enable or disable or negotiate parameters associated with other modes of operations (such as an enhanced multi-link single radio (eMLSR) mode, an enhanced multi-link multi radio (eMLMR) mode, a coexistence mode, a non-primary channel access mode, a low power listen (LPL) mode or any combination thereof). In some cases, the AP may be required to either accept all modes or reject all requested modes. For example, if the STA requests the enablement of the DSO mode and the eMLSR mode, and the AP cannot accept the enablement of the eMLSR mode the AP may be required to reject both the DSO mode and eMLSR mode.

As one example, FIG. 5B depicts a DSO timeline 501 in which previously-selected DSO sub-bands are still considered valid after a rejected change to the DSO sub-band selection and operation continues in accordance with the previously-selected DSO sub-bands.

At 528, the STA may transmit a frame to enable the DSO mode. In some examples, the STA may include a bitmap to indicate one or more selected DSO sub-bands (such as via a bitmap, such as 1111 0000 1111 0000). At 530, the AP may transmit a control acknowledgement.

At 532, the AP may transmit a frame to confirm DSO enablement. In some examples, the AP may transmit an indication of acceptance of the selected DSO sub-bands indicated at 528 (such as via a bitmap, such as 1111 0000 1111 0000). At 534, the STA may transmit a control acknowledgement.

At 536, the AP may allocate resources for the STA within or associated with the selected DSO sub-bands. At 538, the STA may respond within an allocated DSO sub-band. At 540, the AP and the STA may communicate within an allocated DSO sub-band. Further, the AP may communicate with other STAs (such as those that have also transmitted selection indications) in other sub-bands.

At 542, the AP may transmit a frame to update the selection of DSO sub-bands. In some examples, the AP may include a bitmap (such as via a bitmap, such as 1111 0000 0000 1111). At 544, the STA may transmit a control acknowledgement.

At 546, the STA may transmit a response frame that rejects the update to the selection of DSO sub-bands. At 548, the AP may transmit a control acknowledgement.

At 550, the AP may allocate resources for the STA within or associated with the originally selected DSO sub-bands (such as those selected at 528). At 552, the STA may respond within an allocated DSO sub-band. At 554, the AP and the STA may communicate within an allocated DSO sub-band. Further, the AP may communicate with other STAs (such as those that have also transmitted selection indications) in other sub-bands.

As another example, FIG. 5C depicts a DSO timeline 502 in which the AP and the STA continue to operate in the DSO mode only on the sub-bands that are accepted in the latest exchange.

At 556, the STA may transmit a frame to enable the DSO mode. In some examples, the STA may include a bitmap to indicate additional DSO sub-bands intended to be added to a previous selection of DSO sub-bands (such as via a bitmap, such as 1111 1111 1111 0000). At 558, the AP may transmit a control acknowledgement.

At 560, the AP may transmit a frame to confirm DSO enablement. In some examples, the AP may transmit an indication of acceptance of the addition to the selected DSO sub-bands (such as via a bitmap, such as 1111 0000 1111 1111). At 562, the STA may transmit a control acknowledgement.

At 564, the AP may allocate resources for the STA within or associated with the selected DSO sub-bands (such as including the addition to the selected DSO sub-bands). At 566, the STA may respond within an allocated DSO sub-band. At 568, the

AP and the STA may communicate within an allocated DSO sub-band. Further, the AP may communicate with other STAs (such as that have also transmitted selection indications) in other sub-bands.

At 570, the AP may transmit a frame to modify the selection of the DSO sub-bands (such as by including a first request to remove one or more selected DSO sub-bands from the selection and a second request to add one or more DSO sub-bands to the selection). In some examples, the AP may include a bitmap to indicate such a modification (such as 1111 1111 0000 1111). At 572, the STA may transmit a control acknowledgment.

At 574, the STA may transmit a response frame that accepts the first request to remove one or more DSO sub-bands from the selection and that rejects the second request to add one or more DSO sub-bands from the selection. In some examples, the STA may indicate such a response via a bitmap (such as 1111 1111 0000 0000). At 576, the AP may transmit a control acknowledgement.

At 578, the AP may allocate resources for the STA within or associated with the selected DSO sub-bands (such as in accordance with the acceptance of the removal of one or more DSO sub-bands from the selection and in accordance with the denial of the addition of one or more DSO sub-bands to the selection). At 580, the STA may respond within an allocated DSO sub-band. At 582, the AP and the STA may communicate within an allocated DSO sub-band. Further, the AP may communicate with other STAs (such as those that have also transmitted selection indications) in other sub-bands.

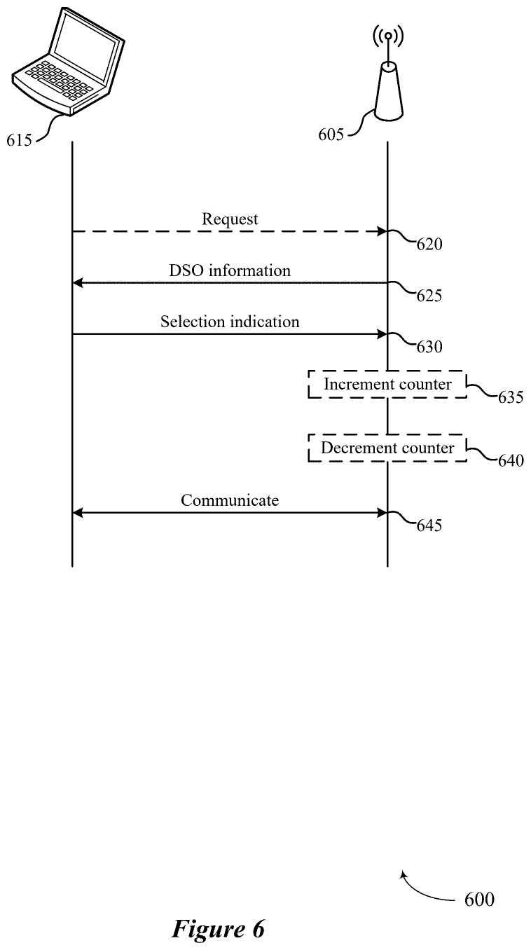

FIG. 6 shows an example of a process flow 600 that supports dynamic sub-band operation information.

The process flow 600 may implement various aspects of the present disclosure described herein. The elements described in the process flow 600 (such as AP 605 and STA 615) may be examples of similarly named elements described herein.

In the following description of the process flow 600, the operations between the various entities or elements may be performed in different orders or at different times. Some operations also may be left out of the process flow 600, or other operations may be added. Although the various entities or elements are shown performing the operations of the process flow 600, some aspects of some operations also may be performed by other entities or elements of the process flow 600 or by entities or elements that are not depicted in the process flow, or any combination thereof.

At 620, the AP 605 may receive, from the first STA 615, a request to provide the information and transmission of the information is based on reception of the request. In some examples, the request includes a selection of individual sub-band basis reporting or sub-band group basis reporting.

At 625, the AP 605 may transmit information associated with dynamic sub-band operation (DSO) between the AP and one or more stations (STAs) associated with the AP and the information may indicate one or more of: which of the one or more STAs are associated with each DSO sub-band of a plurality of DSO sub-bands supported by the AP and a recommendation for one or more DSO sub-bands of the plurality of DSO sub-bands supported by the AP. In some examples, the information may indicate which of the one or more STAs may have transmitted DSO sub-band selection indications. In some examples, the information may indicate which of the one or more STAs have transmitted DSO sub-band selection indications and that have communicated with the AP within a threshold first amount of time. In some examples, the information may indicate a running average quantity of the one or more STAs that may have transmitted DSO sub-band selection indications and that may have communicated with the AP within the threshold first amount of time. In some examples, the running average quantity is indicated with respect to the threshold first amount of time or with respect to a second amount of time different than the threshold first amount of time.

In some examples, to transmit the processing information, the AP 605 may transmit the information via a unicast transmission in response to reception of a query from the first STA 615, transmit the information via a broadcast transmission, both.

In some examples, transmitting the information via the unicast transmission in response to reception of the query from the first STA 615 may include transmitting the information on a per-sub-band basis. In some examples, transmitting the information via the broadcast transmission may include transmitting the information on a per-sub-band group-basis.

In some examples, the information is indicated on a sub-band group basis, and the information may include one or more indications of greatest quantities of STAs associated with individual DSO sub-bands of each sub-band group or average quantities of STAs associated with individual DSO sub-bands of each sub-band group.

In some examples, the AP 605 may transmit an indication of a multiplier value to be applied to STA 615 quantity values indicated in the information that are associated with each DSO sub-band of the plurality of DSO sub-bands.

In some examples, to transmit the information, the AP 605 may indicate one or more DSO sub-bands of the plurality of DSO sub-bands as disfavored or disallowed for selection. In some examples, the one or more DSO sub-bands of the plurality of DSO sub-bands are indicated as disfavored or disallowed based on one or more traffic profiles associated with the plurality of DSO sub-bands.

In some examples, the recommendation is based on one or more traffic profiles associated with the plurality of DSO sub-bands, a prioritization of the one or more DSO sub-bands, or any combination thereof.

In some examples, to transmit the information, the AP 605 may transmit the information in a dedicated information element or in an operations information element.

In some examples, the information is transmitted in accordance with the selection of individual sub-band basis reporting or sub-band group basis reporting.

In some examples, the information may indicate one or more quantities of the STAs associated with each DSO sub-band on an individual DSO sub-band basis, on a DSO sub-band group basis, or both.

At 630, the AP 605 may receive, from a first STA 615, an indication of one or more selected DSO sub-bands of the plurality of DSO sub-bands.

At 635, the AP 605 may increment one or more counters associated with the one or more selected DSO sub-bands based on reception of the indication of the one or more selected DSO sub-bands of the plurality of DSO sub-bands.

At 640, the AP 605 may decrement one or more counters associated with individual DSO sub-bands of the plurality of DSO sub-bands based on determining that a STA 615 of the one or more STAs is no longer operating in a DSO mode.

At 645, the AP 605 may communicate with the first STA 615 in accordance with at least one of the one or more selected DSO sub-bands.

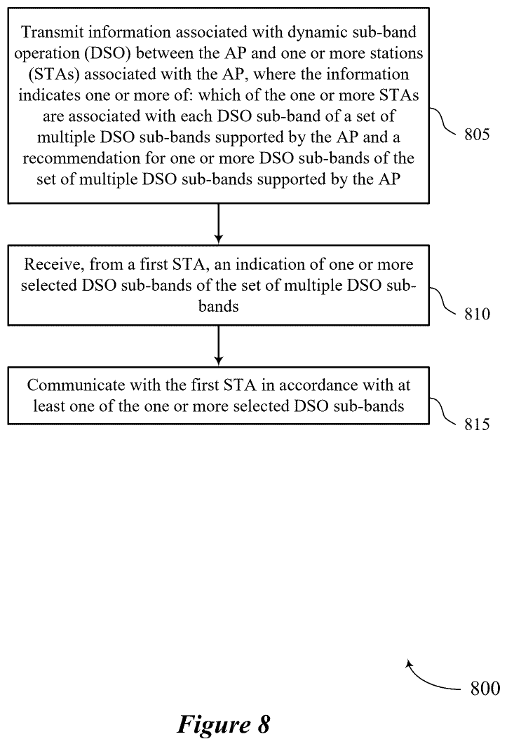

FIG. 7 shows a block diagram of an example wireless communication device 700 that supports dynamic sub-band operation information. In some examples, the wireless communication device 700 is configured to perform the process 800 described with reference to FIG. 8. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a DSO information component 725, a DSO sub-band selection component 730, a DSO communication component 735, an active communication component 740, a counter component 745, a basis component 750, a multiplier component 755, a traffic component 760, a critical update component 765, an information element component 770, and a request component 775. Portions of one or more of the DSO information component 725, the DSO sub-band selection component 730, the DSO communication component 735, the active communication component 740, the counter component 745, the basis component 750, the multiplier component 755, the traffic component 760, the critical update component 765, the information element component 770, and the request component 775 may be implemented at least in part in hardware or firmware. For example, one or more of the DSO information component 725, the DSO sub-band selection component 730, the DSO communication component 735, the active communication component 740, the counter component 745, the basis component 750, the multiplier component 755, the traffic component 760, the critical update component 765, the information element component 770, and the request component 775 may be implemented at least in part by at least a processor or a modem. In some examples, portions of one or more of the DSO information component 725, the DSO sub-band selection component 730, the DSO communication component 735, the active communication component 740, the counter component 745, the basis component 750, the multiplier component 755, the traffic component 760, the critical update component 765, the information element component 770, and the request component 775 may be implemented at least in part by a processor and software in the form of processor-executable code stored in memory.

Additionally, or alternatively, the wireless communication device 700 may support wireless communications in accordance with examples as disclosed herein. The DSO information component 725 is configurable or configured to transmit information associated with dynamic sub-band operation (DSO) between the AP and one or more stations (STAs) associated with the AP, where the information indicates one or more of: which of the one or more STAs are associated with each DSO sub-band of a set of multiple DSO sub-bands supported by the AP and a recommendation for one or more DSO sub-bands of the set of multiple DSO sub-bands supported by the AP. The DSO sub-band selection component 730 is configurable or configured to receive, from a first STA, an indication of one or more selected DSO sub-bands of the set of multiple DSO sub-bands. The DSO communication component 735 is configurable or configured to communicate with the first STA in accordance with at least one of the one or more selected DSO sub-bands.

In some examples, the information indicates which of the one or more STAs have transmitted DSO sub-band selection indications.

In some examples, the information indicates which of the one or more STAs have transmitted DSO sub-band selection indications and that have communicated with the AP within a threshold first amount of time.

In some examples, the information indicates a running average quantity of the one or more STAs that have transmitted DSO sub-band selection indications and that have communicated with the AP within the threshold first amount of time. In some examples, the running average quantity is indicated with respect to the threshold first amount of time or with respect to a second amount of time different than the threshold first amount of time.

In some examples, the counter component 745 is configurable or configured to increment one or more counters associated with the one or more selected DSO sub-bands based on reception of the indication of the one or more selected DSO sub-bands of the set of multiple DSO sub-bands.

In some examples, the counter component 745 is configurable or configured to decrement one or more counters associated with individual DSO sub-bands of the set of multiple DSO sub-bands based on determining that a STA of the one or more STAs is no longer operating in a DSO mode.

In some examples, to support transmitting the information, the DSO information component 725 is configurable or configured to transmit the information via a unicast transmission in response to reception of a query from the first STA. In some examples, to support transmitting the information, the DSO information component 725 is configurable or configured to transmit the information via a broadcast transmission; or both.

In some examples, transmitting the information via the unicast transmission in response to reception of the query from the first STA includes transmitting the information on a per-sub-band basis. In some examples, transmitting the information via the broadcast transmission includes transmitting the information on a per-sub-band group-basis.

In some examples, the information is indicated on a sub-band group basis. In some examples, the information includes one or more indications of greatest quantities of STAs associated with individual DSO sub-bands of each sub-band group or average quantities of STAs associated with individual DSO sub-bands of each sub-band group.

In some examples, the multiplier component 755 is configurable or configured to transmit an indication of a multiplier value to be applied to STA quantity values indicated in the information that are associated with each DSO sub-band of the set of multiple DSO sub-bands.

In some examples, to support transmitting the information, the DSO information component 725 is configurable or configured to indicate one or more DSO sub-bands of the set of multiple DSO sub-bands as disfavored or disallowed for selection.

In some examples, the one or more DSO sub-bands of the set of multiple DSO sub-bands are indicated as disfavored or disallowed based on one or more traffic profiles associated with the set of multiple DSO sub-bands.

In some examples, the recommendation is based on one or more traffic profiles associated with the set of multiple DSO sub-bands, a prioritization of the one or more DSO sub-bands, or any combination thereof.

In some examples, the critical update component 765 is configurable or configured to transmit critical update signaling based on an update to the information.

In some examples, to support transmitting the information, the information element component 770 is configurable or configured to transmit the information in a dedicated information element or in an operations information element.

In some examples, the request component 775 is configurable or configured to receive, from the first STA, a request to provide the information, where transmission of the information is based on reception of the request.

In some examples, the request includes a selection of individual sub-band basis reporting or sub-band group basis reporting. In some examples, the information is transmitted in accordance with the selection.

In some examples, the information indicates one or more quantities of the STAs associated with each DSO sub-band on an individual DSO sub-band basis, on a DSO sub-band group basis, or both.

FIG. 8 shows a flowchart illustrating an example process 800 performable by or at an AP that supports dynamic sub-band operation information. The operations of the process 800 may be implemented by an AP or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 805, the AP may transmit information associated with dynamic sub-band operation (DSO) between the AP and one or more stations (STAs) associated with the AP, where the information indicates one or more of: which of the one or more STAs are associated with each DSO sub-band of a set of multiple DSO sub-bands supported by the AP and a recommendation for one or more DSO sub-bands of the set of multiple DSO sub-bands supported by the AP. The operations of 805 may be performed in accordance with examples as disclosed herein. In some implementations, aspects of the operations of 805 may be performed by a DSO information component 725 as described with reference to FIG. 7.

In some examples, in 810, the AP may receive, from a first STA, an indication of one or more selected DSO sub-bands of the set of multiple DSO sub-bands. The operations of 810 may be performed in accordance with examples as disclosed herein. In some implementations, aspects of the operations of 810 may be performed by a DSO sub-band selection component 730 as described with reference to FIG. 7.

In some examples, in 815, the AP may communicate with the first STA in accordance with at least one of the one or more selected DSO sub-bands. The operations of 815 may be performed in accordance with examples as disclosed herein. In some implementations, aspects of the operations of 815 may be performed by a DSO communication component 735 as described with reference to FIG. 7.

Implementation examples are described in the following numbered clauses:

Aspect 1: A method for wireless communications at an AP, including: transmitting information associated with dynamic sub-band operation (DSO) between the AP and one or more stations (STAs) associated with the AP, where the information indicates one or more of: which of the one or more STAs are associated with each DSO sub-band of a plurality of DSO sub-bands supported by the AP and a recommendation for one or more DSO sub-bands of the plurality of DSO sub-bands supported by the AP; receiving, from a first STA, an indication of one or more selected DSO sub-bands of the plurality of DSO sub-bands; and communicating with the first STA in accordance with at least one of the one or more selected DSO sub-bands.

Aspect 2: The method of aspect 1, where the information indicates which of the one or more STAs have transmitted DSO sub-band selection indications.

Aspect 3: The method of any of aspects 1 through 2, where the information indicates which of the one or more STAs have transmitted DSO sub-band selection indications and that have communicated with the AP within a threshold first amount of time.

Aspect 4: The method of aspect 3, where the information indicates a running average quantity of the one or more STAs that have transmitted DSO sub-band selection indications and that have communicated with the AP within the threshold first amount of time; and the running average quantity is indicated with respect to the threshold first amount of time or with respect to a second amount of time different than the threshold first amount of time.

Aspect 5: The method of any of aspects 1 through 4, further including: incrementing one or more counters associated with the one or more selected DSO sub-bands based at least in part on reception of the indication of the one or more selected DSO sub-bands of the plurality of DSO sub-bands.

Aspect 6: The method of any of aspects 1 through 5, further including: decrementing one or more counters associated with individual DSO sub-bands of the plurality of DSO sub-bands based at least in part on determining that a STA of the one or more STAs is no longer operating in a DSO mode.

Aspect 7: The method of any of aspects 1 through 6, where transmitting the information includes: transmitting the information via a unicast transmission in response to reception of a query from the first STA; transmitting the information via a broadcast transmission; or both.

Aspect 8: The method of aspect 7, where transmitting the information via the unicast transmission in response to reception of the query from the first STA includes transmitting the information on a per-sub-band basis; and transmitting the information via the broadcast transmission includes transmitting the information on a per-sub-band group-basis.

Aspect 9: The method of any of aspects 1 through 8, where the information is indicated on a sub-band group basis; and the information includes one or more indications of greatest quantities of STAs associated with individual DSO sub-bands of each sub-band group or average quantities of STAs associated with individual DSO sub-bands of each sub-band group.

Aspect 10: The method of any of aspects 1 through 9, further including: transmitting an indication of a multiplier value to be applied to STA quantity values indicated in the information that are associated with each DSO sub-band of the plurality of DSO sub-bands.

Aspect 11: The method of any of aspects 1 through 10, where transmitting the information includes: indicating one or more DSO sub-bands of the plurality of DSO sub-bands as disfavored or disallowed for selection.

Aspect 12: The method of aspect 11, where the one or more DSO sub-bands of the plurality of DSO sub-bands are indicated as disfavored or disallowed based at least in part on one or more traffic profiles associated with the plurality of DSO sub-bands.

Aspect 13: The method of any of aspects 1 through 12, where the recommendation is based at least in part on one or more traffic profiles associated with the plurality of DSO sub-bands, a prioritization of the one or more DSO sub-bands, or any combination thereof.

Aspect 14: The method of any of aspects 1 through 13, further including: transmitting critical update signaling based at least in part on an update to the information.

Aspect 15: The method of any of aspects 1 through 14, where transmitting the information includes: transmitting the information in a dedicated information element or in an operations information element.

Aspect 16: The method of any of aspects 1 through 15, further including: receiving, from the first STA, a request to provide the information, where transmission of the information is based at least in part on reception of the request.

Aspect 17: The method of aspect 16, where the request includes a selection of individual sub-band basis reporting or sub-band group basis reporting; and the information is transmitted in accordance with the selection.

Aspect 18: The method of any of aspects 1 through 17, where the information indicates one or more quantities of the STAs associated with each DSO sub-band on an individual DSO sub-band basis, on a DSO sub-band group basis, or both.

Aspect 19: An AP for wireless communications, including one or more memories storing processor-executable code, and one or more processors coupled with the one or more memories and individually or collectively operable to execute the code to cause the AP to perform a method of any of aspects 1 through 18.

Aspect 20: An AP for wireless communications, including at least one means for performing a method of any of aspects 1 through 18.

Aspect 21: A non-transitory computer-readable medium storing code for wireless communications, the code including instructions executable by one or more processors to perform a method of any of aspects 1 through 18.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communications at an access point (AP), comprising:
a processing system that includes processor circuitry and memory circuitry that stores code, the processing system configured to cause the AP to:
transmit information associated with dynamic sub-band operation (DSO) between the AP and one or more stations (STAs) associated with the AP, wherein the information indicates which of the one or more STAs are associated with cach DSO sub-band of a plurality of DSO sub-bands supported by the AP and a recommendation for one or more DSO sub-bands of the plurality of DSO sub-bands supported by the AP;
receive, from a first STA, an indication of one or more selected DSO sub-bands of the plurality of DSO sub-bands; and
communicate with the first STA in accordance with at least one of the one or more selected DSO sub-bands.

2. The apparatus of claim 1, wherein the information indicates which of the one or more STAs have transmitted DSO sub-band selection indications.

3. The apparatus of claim 1, wherein the information indicates which of the one or more STAs have transmitted DSO sub-band selection indications and that have communicated with the AP within a threshold first amount of time.

4. The apparatus of claim 3, wherein:
the information indicates a running average quantity of the one or more STAs that have transmitted DSO sub-band, selection indications and that have communicated with the AP within the threshold first amount of time; and
the running average quantity is indicated with respect to the threshold first amount of time or with respect to a second amount of time different than the threshold first amount of time.

5. The apparatus of claim 1, wherein the processing system is further configured to cause the AP to increment one or more counters associated with the one or more selected DSO sub-bands based at least in part on reception of the indication of the one or more selected DSO sub-bands of the plurality of DSO sub-bands.

6. The apparatus of claim 1, wherein the processing system is further configured to cause the AP to decrement one or more counters associated with individual DSO sub-bands of the plurality of DSO sub-bands based at least in part on determining that a STA of the one or more STAs is no longer operating in a DSO mode.

7. The apparatus of claim 1, wherein, to transmit the information, the processing system is further configured to cause the AP to:
transmit the information via a unicast transmission in response to reception of a query from the first STA;
transmit the information via a broadcast transmission; or both.

8. The apparatus of claim 7, wherein:
transmission of the information via the unicast transmission in response to reception of the query from the first STA comprises transmission of the information on a per-sub-band basis; and
transmission of the information via the broadcast transmission comprises transmission of the information on a per-sub-band group-basis.

9. The apparatus of claim 1, wherein:
the information is indicated on a sub-band group basis; and
the information comprises one or more indications of greatest quantities of STAs associated with individual DSO sub-bands of each sub-band group or average quantities of STAs associated with individual DSO sub-bands of each sub-band group.

10. The apparatus of claim 1, wherein the processing system is further configured to cause the AP to transmit an indication of a multiplier value to be applied to STA quantity values indicated in the information that are associated with each DSO sub-band of the plurality of DSO sub-bands.

11. The apparatus of claim 1, wherein, to transmit the information, the processing system is further configured to cause the AP to indicate one or more DSO sub-bands of the plurality of DSO sub-bands as disfavored or disallowed for selection.

12. The apparatus of claim 11, wherein the one or more DSO sub-bands of the plurality or DSO sub-bands are indaicated as the disfavored or disallowed based at least in part on one or more traffic profiles associated with the plurality of DSO sub-bands.

13. The apparatus of claim 1, wherein the recommendation is based at least in part on one or more traffic profiles associated with the plurality of DSO sub-bands, a prioritization of the one or more DSO sub-bands, or any combination thereof.

14. The apparatus of claim 1, wherein the processing system is further configured to cause the AP to transmit critical update signaling based at least in part on an update to the information.

15. The apparatus of claim 1, wherein, to transmit the information, the processing system is further configured to cause the AP to transmit the information in a dedicated information element or in an operations information element.

16. The apparatus of claim 1, wherein the processing system is further configured to cause the AP to receive, from the first STA, a request to provide the information, wherein transmission of the information is based at least in part on reception of the request.

17. The apparatus of claim 16, wherein:
the request includes a selection of individual sub-band basis reporting or sub-band group basis reporting; and
the information is transmitted in accordance with the selection.

18. The apparatus of claim 1, wherein the information indicates one or more quantities of the one or more STAs associated with each DSO sub-band on an individual DSO sub-band basis, on a DSO sub-band group basis, or both.

19. A method for wireless communications at an access point (AP), comprising:
transmitting information associated with dynamic sub-band operation (DSO) between the AP and one or more stations (STAs) associated with the AP, wherein the information indicates which of the one or more STAs are associated with each DSO sub-band of a plurality of DSO sub-bands supported by the AP and a recommendation for one or more DSO sub-bands of the plurality of DSO sub-bands supported by the AP;
receiving, from a first STA, an indication of one or more selected DSO sub-bands of the plurality of DSO sub-bands; and
communicating with the first STA in accordance with at least one of the one or more selected DSO sub-bands.

20. The method of claim 19, wherein the information indicates which of the one or more STAs have transmitted DSO sub-band selection indications.
